(19) United States
(12) Patent Application Publication
(10) Pub. No.: US 2011/0282597 A1
(43) Pub. Date: Nov. 17, 2011

(54) METHOD FOR DETERMINING A VISCOSITY PARAMETER OF A MOTOR OIL AS WELL AS A CONTROL DEVICE FOR AN ELECTRONIC ENGINE CONTROL

(75) Inventor: Piergiacomo Traversa, Nurnberg (DE)

(73) Assignee: SCHAEFFLER TECHNOLOGIES GMBH & CO. KG, Herzogenaurach (DE)

(21) Appl. No.: 13/109,322

(22) Filed: May 17, 2011

(30) Foreign Application Priority Data
May 17, 2010 (DE) 102010020757.8

(51) Int. Cl. G01N 11/00; G06F 19/00

(52) U.S. Cl. 702/50; 73/54.01; 73/54.42

(57) ABSTRACT

A method for determining a viscosity parameter of a motor oil in an internal combustion engine, wherein a plurality of operating parameters characterizing an operating state of the internal combustion engine are detected and/or determined for an electronic engine control. Several parameters allowing at least a rough prediction on the viscosity of the motor oil are each evaluated for an individual prediction on the viscosity of the motor oil at different times from these operating parameters, and changes in the individual predictions for comparable working points of the internal combustion engine relative to a state of new motor oil are detected. The viscosity parameter is determined from the changes in the several individual predictions. A corresponding control device for the electronic engine control is also provided.

### CROSS-REFERENCE TO RELATED APPLICATIONS

This application claims the benefit of German Patent Application No. 10 2010 020 757.8, filed May 17, 2010, which is incorporated herein by reference as if fully set forth.

### FIELD OF THE INVENTION

The invention relates to a method for determining a viscosity parameter of a motor oil in an internal combustion engine, wherein a plurality of operating parameters characterizing an operating state of the internal combustion engine are detected and/or determined for an electronic engine control. The invention further relates to a control device for an electronic engine control with reference to the detected and/or determined operating parameters.

The invention here concerns, in particular, that the viscosity of the motor oil being used has a not insignificant influence on the operating behavior of an internal combustion engine, but the current status is taken into account only insufficiently for an electronic engine control. Even for modern multi-grade oils with synthetic additives, the viscosity changes as a function of the period of use due to aging of the additives. For an electronic engine control, the oil viscosity plays a role especially when the internal combustion engine is controlled by components that can be actuated hydraulically, wherein the motor oil is used as the hydraulic fluid.

### BACKGROUND

In modern engine vehicles, today for reasons of minimizing pollution and also reducing consumption, the so-called gas-exchange valves, that is, the intake and/or exhaust valves for the internal combustion engine, are controlled as a function of load. Here, different systems are used. All of the systems have in common that the closing and/or opening times of the gas-exchange valves are changed in relation to the crankshaft position (rotational angle) as a function of the operating state, in particular, as a function of load.

In engine vehicles today, camshaft adjusters that are hydraulically actuated are already in use that allow a setting of the phase position of the camshaft with respect to crankshaft as a function of the respective operating state. To this end, the camshaft adjuster comprises a stator unit that is locked in rotation with the crankshaft and in which is mounted a rotor unit that is connected rigidly to the camshaft. The rotor unit typically has rotor vanes that are arranged between pressure chambers that can be pressurized with the hydraulic fluid. By the use of inlet and outlet valves, hydraulic fluid can be fed to or bled from the pressure chambers, wherein the rotor vanes can be moved relative to the stator unit. As the hydraulic fluid, motor oil is typically used. For building up the pressure, existing oil pumps are used. The control valves provided for filling or emptying the pressure chambers are constructed, in particular, as solenoid valves.

A hydraulic camshaft adjustment system is to be taken, for example, from EP 1 544 419 A1.

From the article “Electrohydraulic valve control with the ‘MultiAir’ (MA) method” from the engine-technology journal MTZ 12/2009, an alternative, hydraulic control system for the direct control of the gas-exchange valves is to be taken. For this electrohydraulic valve control it is provided that the movement of the camshaft is transmitted via the hydraulic fluid to each gas-exchange valve. A control or switch valve constructed especially as a solenoid valve is provided for the control. In the closed state, the camshaft is connected to each gas-exchange valve by a so-called hydraulic linkage, so that the gas-exchange valve necessarily follows a cam of the camshaft. Through also partial opening of the switch valve, the hydraulic fluid can escape into a compensation or pressure space, so that the gas-exchange valve is decoupled from the cam movement. In this way, there is the possibility to vary the opening time, the closing time, and also the stroke of the gas-exchange valve within an envelope curve specified by the movement of the cam. This variation can be performed in a cylinder-selective way.

In view of the high efficiency required in modern internal combustion engines with simultaneously low pollutant emission, a correct control of the gas-exchange valves is very important. In hydraulic systems, in particular, the quality of the motor oil being used has a significant effect on the operation. In particular, in its effectiveness, the hydraulic control is sensitive to oscillations in the viscosity of the oil being used. Depending on the operation, such oscillations appear due to the different oil temperatures that appear. As emerges from the mentioned article “Electrohydraulic valve control with the “MultiAir” method,” the temperature-dependent oil viscosity oscillations have previously been taken into account in a model-based control algorithm that takes into account the measurement values of an oil temperature sensor. Here, however, the viscosity of the motor oil, as well as other influencing factors, such as, for example, aging of the motor oil, wear, or contamination, are not taken into account.

### SUMMARY

Starting from this situation, the invention is based on the objective of providing a method for determining a viscosity parameter of a motor oil in an internal combustion engine, and also a corresponding control device for electronic engine control, wherein at least qualitative statements on the current viscosity of the motor oil can be obtained and processed accordingly as much as possible without additional expense.

The objective is met according to the invention by a method for determining a viscosity parameter of a motor oil in an internal combustion engine, wherein, for an electronic engine control, a plurality of operating parameters characterizing an operating state of the internal combustion engine is detected and/or determined. Here, at different times, several parameters allowing at least a rough conclusion on the viscosity of the motor oil are evaluated from these operating parameters for each individual prediction on the viscosity of the motor oil, changes in the individual predictions at comparable working points of the internal combustion engine relative to a state of new motor oil are detected, and the viscosity parameter is determined from the changes in the several individual predictions.

Here, the invention starts from the idea that in an electronic engine control, during the operation of the internal combustion engine, operating parameters characterizing the operating state are detected and/or determined continuously and input into the control. The value of a few of these operating parameters allows, in principle, at least one rough conclusion on the viscosity of the motor oil being used. Such a rough conclusion does not need to be an absolute value of the viscosity of the motor oil. Instead, in principle, there must be only a relationship between the parameter and a conclusion on the viscosity of the motor oil. Such a relationship or such a rough conclusion is given, for example, when the corresponding operating parameters can conclude, for example, whether the motor oil has a rather large or rather small viscosity in comparison with motor oils that are typically used or whether the viscosity is too small or too large for operating the internal combustion engine. Such a conclusion, however, could also already have a value that indicates a change in viscosity, for example, whether the viscosity has become smaller or larger.

A corresponding conclusion can be taken, for example, from a parameter that characterizes the engine friction and is derived in modern engine controls, for example, while idling, from the difference between the desired rotational speed and the actual rotational speed. A rather high friction value could provide evidence for a rather high viscosity. Conversely, a rather lower friction value gives evidence for a rather low viscosity. Likewise, for example, the time period that elapses after a starting process of the internal combustion engine until reaching a desired oil pressure permits a rough conclusion on the given viscosity of the motor oil. A small time span gives evidence for a rather low viscosity of the motor oil and vice versa.

The invention further assumes that the individual predictions obtained from individual rough conclusions on the viscosity of the motor oil could be compressed into a more precise conclusion on a viscosity parameter, if the parameters detected at different times or evaluated individual predictions at comparable operating points of the internal combustion engine are compared with each other and in this way changes over time are made visible over the operating period. From such changes, in particular, the direction of a change in viscosity could also be determined, which already represents useful information. By using the size of the changes observed per unit of time, it is further possible to determine the extent of a change in viscosity that has occurred. Here, in order to have a reference point for a possible calibration, the changes are detected with respect to a state of new motor oil. Here, a newly added motor oil is assumed, for example, after an oil change or in the case of a new vehicle, which has properties suitable for the internal combustion engine and is optionally already stored with these properties in the engine control.

A detection of the time changes of comparable parameters or comparable individual predictions with respect to the state of the new motor oil allows, in this respect, changes in the viscosity of the motor oil to be detected and these to be evaluated in terms of quality. Under certain preliminary conditions, a quantitative detection of the viscosity is also possible.

The phrase of comparable operating point of the internal combustion engine is here understood in that the additional factors decisively influencing the oil viscosity on the part of the detected parameter are essentially comparable. For example, if friction values of the engine are compared with each other at different times, then the oil temperature must be essentially equal, in order to make a qualitative and optionally quantitative conclusion on the changed oil viscosity.

The value of the determined viscosity parameter is further increased in that the changes in several suitable parameters or the changes in several individual predictions derived from these parameters are compared with each other. Thus, for example, several individual predictions indicating an equal change direction and an equal magnitude of the change in viscosity reinforce the overall conclusion. On the other hand, individual parameters that have a higher informational content with respect to oil viscosity are weighted higher in the determination of the viscosity parameter than other parameters whose informational content are lower with respect to oil viscosity or are loaded with higher errors.

In principle, the invention could be used for all internal combustion engines in which operating parameters are queried or made available for the querying of the respective operating state, that is, an electronic engine control with corresponding sensor systems is provided. Typically, operating parameters can always be retrieved here that allow at least a rough conclusion on the state of the viscosity of the motor oil.

The invention could be added as separate hardware to an existing engine control. Preferably, however, the invention is realized by a corresponding modification to the software of the existing engine control. In this respect, the invention allows a qualitative and optionally quantitative conclusion on the viscosity of the motor oil to be obtained without changing the existing installation of an already provided engine control, wherein this conclusion can be used, in particular, as an input parameter for the engine control itself. In this way, the control is trained to sufficiently take into account the current viscosity. The operating states optimized with respect to the consumption and the output of the internal combustion engine are actually also controlled despite the changed viscosity of the motor oil.

Through the plurality of observed operating parameters, as well as by the observation of the time changes in the individual predictions derived from these parameters, the current state of the viscosity of the motor oil is detected. The viscosity parameter derived from these values can be, for example, a viscosity grade of the motor oil, a quantitative change in the viscosity relative to the motor oil in the new state, optionally the viscosity itself, or, in the simplest case, for large detected changes, an indicating parameter for an oil change that has taken place or for a current viscosity in which the internal combustion engine no longer experiences sufficient lubrication or can no longer start due to viscosity that is too high.

The invention is especially also suitable for preventing damage to the internal combustion engine due to a possibly incorrect viscosity caused by aging, contamination, or wear of the motor oil.

The invention further offers the big advantage that it manages without a viscosity sensor that is associated with additional costs and also delivers measurement results that can be used only in certain temperature ranges. Thus, the invention offers, in particular, the analysis of the viscosity of the motor oil at relatively low oil temperatures. Changes in the motor oil caused by aging, wear, or the introduction of foreign particles lead, viewed absolutely, to the greatest changes to viscosity. The invention uses only the sensors already present in an engine control, so that no additional costs are generated. By deriving the individual predictions from the suitable operating parameters, the viscosity of the motor oil is also determined directly at each place of detection. This is important especially for a hydraulic control of the gas-exchange valves. It has been shown, namely, that their adjustment behavior gives a direct indication of the present oil viscosity. In contrast, a sensor for measuring the oil viscosity is typically placed away from the actual active components that are actuated hydraulically. For a corresponding measurement of the oil viscosity, such a sensor is to be placed in the oil pan.

In one preferred construction, the temperature of the motor oil is detected, wherein the available parameter range is calibrated, for temperatures above a specified limiting value, to a first range of prediction values for classifying the oil and is calibrated, for temperatures below the limiting value, to a second region of prediction values for classifying the oil.

This construction uses the fact that the temperature dependency of the viscosity of the motor oils, especially also of multi-grade oils, falls into two separate ranges that can each be described by a linear relationship with slopes that are different from each other. In a low-temperature range, the drop in viscosity relative to increasing temperatures is greater than in a high-temperature range. The boundary between these two ranges lies at a temperature of approximately 10° C. depending on the respective motor oil. This property of motor oils is condensed, for example, in the SAE classification that basically provides a designation of the type x W-y for multi-grade oils, wherein x specifies the low-temperature viscosity and y specifies the high-temperature viscosity. A motor oil of the classification SAE 10 W-60 has, according to the classification, a low-temperature viscosity of SAE10 and a high-temperature viscosity of SAE W-60. Different viscosity dependencies of the motor oils in a low-temperature range and in a high-temperature range are desired. In particular, at high temperatures, the viscosity should decrease only slightly, so that a sufficiently high reliability of lubrication is given at higher outside and engine temperatures. The correspondingly desired viscosity is here achieved for modern multi-grade oils through corresponding synthetic additives. However, these lose their effect more and more with aging and wear, so that the viscosity changes, in part drastically, in the course of the use of the motor oil.

If the parameter range available for the selected operating parameters, each dependent on a limiting value for the measured oil temperature, is calibrated once to a first range of prediction values for classifying the oil and once to a second range of prediction values for classifying the oil, then this allows qualitative and quantitative conclusions on the change in oil viscosity relative to the new state of the motor oil. In the simplest case, the calibration can be given by a simple linear relationship of both ranges. In this respect, prediction values for classifying the oil are mapped in a linear fashion onto the available parameter range.

If, for example, the friction value of the internal combustion engine is used as a suitable operating parameter, then, in the high-temperature range, the lowest parameter value can be allocated to an oil viscosity that is so low that engine damage could be generated due to a breaking-down lubricating film. The highest measurable parameter value is then allocated, in turn, to an oil viscosity that corresponds to a viscous high-temperature oil. For example, such an oil has, according to the SAE classification, a high-temperature viscosity of W50 or W60. For temperatures below the limiting value, an oil viscosity that is so low that engine damage could be generated during operation is allocated, in turn, to the lowest available parameter value. The highest available friction value then corresponds to an oil viscosity that corresponds approximately to a viscous low-temperature motor oil, for example, a viscosity according to 20W. By means of such a calibration also used for the other operating parameters or the prediction values derived from these parameters, changes can then be detected in the viscosity at comparable operating points of the internal combustion engine and thus can be evaluated qualitatively. By means of monitoring the corresponding parameter value, in the case of a new motor oil and through the corresponding reference to this case, for subsequently detected parameter values, a quantitative conclusion on the current state of the oil viscosity is also possible.

Preferably, the method for an internal combustion engine is used with a hydraulic adjustment of the gas-exchange valves, because just for such a control, the present oil viscosity has an affect on the actually achieved operating state of the internal combustion engine. A corresponding knowledge on the current state of the oil viscosity is thus meaningful for an improvement in the corresponding control. A change in the oil viscosity here leads to a change in the opening and closing times of the solenoid valves arranged in the hydraulic linkage for actuating the gas-exchange valves. From this results, in turn, a change in the opening and closing times of the controlled gas-exchange valves. Just the closing process takes place, in turn, against the hydraulic fluid that must be forced into a compensation chamber for braking the closing speed. Without taking into account the current oil viscosity, for a constant control, the actually desired operating state of the internal combustion engine is no longer achieved.

The same applies, to a certain extent, also for an internal combustion engine that has a mechanical camshaft adjuster. Because the rotor unit is adjusted hydraulically relative to the stator unit, the oil viscosity influences the timing that is needed for setting the phase angle between the camshaft and crankshaft. This influences, in turn, the opening and closing times of the gas-exchange valves, so that for constant control, in turn, the desired operating state cannot be reached correctly.

Preferably, from the detected changes in the individual predictions, an oil grade that is changed in comparison with the new motor oil is determined. Through the quantitative consideration of the change in the individual predictions during the operation of the internal combustion engine and by means of a corresponding allocation of the available parameter ranges it can be determined when the viscosity change has reached such a value that can be a result, in principle, from a viscosity of a motor oil of a different viscosity grade. If, for example, the viscosity grades are stored in the corresponding engine controls, then such a changed viscosity grade could be used directly in the corresponding control, wherein reference is then made to the current status of the oil viscosity.

In other words, the temperature profile of the viscosity of the motor oil being used is determined from the detected changes, that is, the type of motor oil is determined. It is also possible, however, to also determine the temperature profile of the viscosity in the current state by changes detected at different operating points of the internal combustion engine. In this respect, the system could have a self-learning construction in that it learns, over the period, viscosity profiles versus temperature or versus other parameters through corresponding storage of the detected data.

From the changes in the individual predictions, a viscosity that is too low or too high for the internal combustion engine can be determined, wherein further operation or startup of the internal combustion engine is blocked or at least a warning is issued. Here, within the available parameter ranges, the size of the observed change is analyzed and a viscosity that is too high and/or too low is determined for operation of the motor oil for correspondingly specified calibration when a limiting value is reached. If the oil viscosity for low temperatures is too high, then an attempt to start the engine, in particular, is blocked. For a viscosity that is too low according to the detected status for high temperatures, for example, the further operation of the internal combustion engine is blocked, so that engine damage is prevented. Alternatively, warning signals could also be output to the driver.

Preferably, it can be determined from a very rapid and large change in the individual predictions that an oil change has been performed. The method could have a self-learning construction in this respect in that it considers the status detected after a determined oil change to be a changed status for the state of a new motor oil and analyzes future parameter values or individual predictions relative to this state. Here, reference is then made to a possible mechanical wear of the affected engine components.

In one especially preferred construction, the parameters used for the evaluation for an individual prediction are selected from a group containing parameters for characterizing the adjustment speed of a hydraulic component, in particular, an electrically controllable switching valve, parameters for characterizing the exhaust-gas composition, in particular, the oxygen concentration, parameters for characterizing an oil change based on a model due to aging and/or wear, parameters for characterizing the oil pressure, parameters for characterizing the setting speed of a camshaft adjustment, as well as parameters for characterizing a friction value of the internal combustion engine. The temperature itself is not used as such a parameter. The change in oil viscosity taking place over the operating period of the internal combustion engine is detected.

For an engine with camshaft adjustment, the parameters listed here are available or can be derived, in principle, as operating parameters. In the case of a camshaft adjustment by a conventional camshaft adjuster, however, the parameters for characterizing the exhaust-gas composition, in particular, the oxygen concentration, cannot or, in any case, cannot sufficiently provide a conclusion on the current status of the viscosity of the motor oil being used. For engines that have both conventional camshaft adjustment and also a direct hydraulic actuation of the gas-exchange valves, all of the listed parameters are available or could be derived from the existing operating parameters for an engine control. The listed parameters can also provide sufficient evidence for a conclusion with respect to oil viscosity. For an engine that provides direct hydraulic actuation of the gas-exchange valves without camshaft adjustment, the parameters for characterizing the setting speed of a camshaft adjustment are eliminated for characterizing the oil viscosity.

The parameters for characterizing the adjustment speed of a hydraulic component, in particular, an electrically controllable switching valve, can relate, in particular, to the solenoid valve arranged in the hydraulic linkage between the cam and the associated gas-exchange valve or to the control valve for controlling the pressure chambers in a camshaft adjuster. The use of these parameters for characterizing the oil viscosity touches upon the basic idea that the movement sequence of a hydraulic component during an adjustment movement from a first position into a second position depends decisively on the viscosity of the oil being used. Through the use of the viscosity, a friction force counteracting the movement of the hydraulic component is basically exerted, so that the time period for the adjustment movement of the hydraulic component allows a conclusion on the viscosity.

The hydraulic component here involves, in particular, a component controlled by force, but not by mechanical force, from the first position into the second position, such that different friction resistances lead to different time periods for the adjustment movement. This free, not forced movement is also designated as ballistic movement. The force is here applied, for example, by a spring. Through the counteracting, viscosity-dependent friction force of the motor oil, the time period of the adjustment movements varies as a function of the viscosities.

Without the use of additional sensors, the viscosity can be determined from the time period for the adjustment movement of a hydraulic component during the ballistic movement. The hydraulic components used for charging the pressure chambers of a camshaft adjuster or for the hydraulic actuation of the gas-exchange valves are typically solenoid valves. The valve itself moves especially for the ballistic movement between a closed position and an open position that thus form the first and second positions of the switching valve. Because a closing element of the switching valve, like, for example, a valve plate, is guided within the flow path of the oil, the adjustment movement of the closing element is influenced by the viscosity of the motor oil. For a solenoid valve, typically the movement into one position, advantageously into the closed position, is actuated by magnetic force and after deactivation of the magnetic force, the valve travels back into the second position, in particular, into the open position, actuated by spring force.

According to one preferred refinement, the time or adjustment period or the activation period and/or deactivation period is determined from an inductive response of the excitation current. Thus no additional measurement devices are required. The current profile can be taken directly from the control provided here. Determining the viscosity or a corresponding parameter for this purpose is therefore performed just through evaluation (software), without requiring additional hardware components.

By monitoring the changes in the activation or deactivation periods taken, in particular, from the excitation currents, a quantitative change in oil viscosity can be determined directly. In principle, a shortening of a switching period is evidence for reduced oil viscosity. Here, it has been shown, in particular, that a linear relationship exists between the oil viscosity and the observed switching period. The precise determination of the viscosity from the switching periods can be drawn, in particular, from a German Patent Application with the title “Method and also control device for determining a viscosity parameter of an oil” and filed at the same time as the priority application by the same applicant.

The changes in the observed switching times are also here linked preferably with the information of viscosity grades in a low-temperature range and in a high-temperature range.

The parameters for characterizing the exhaust-gas composition, e.g., the oxygen concentration in the exhaust gas, exhibit, in particular, a dependency of the oil viscosity when the engine provides a direct hydraulic actuation of the gas- exchange valves. As already mentioned, by means of the opening and closing times of a solenoid valve located in the hydraulic linkage between the cam and the respective gas-exchange valve, the movement profile of the gas-exchange valve varies within the envelope curve specified by the cam. Through the given dependency of the switching period of the hydraulically actuated solenoid valve on the oil viscosity, the movement profile of the gas-exchange valve also changes. In addition, for a decoupling of the gas-exchange valve, this is closed by spring force against the hydraulic fluid, in order to brake the closing process sufficiently against the engine housing. In this way, however, the ballistic closing process of the gas-exchange valve changes as a function of the viscosity of the motor oil. If the oil becomes more viscous, for example, then an intake valve remains open longer due to the longer closing time. As a result, more oxygen is introduced into the piston space for a constant amount of fuel. The oxygen concentration in the exhaust gas increases.

Thus it is clear that, in particular, the oxygen concentration in the exhaust gas likewise contains evidence on the existing oil viscosity. If, in turn, the change in oxygen concentration in the exhaust gas is observed during the operating period of the internal combustion engine relative to a state with new motor oil, then from this, under consideration of the hydraulic control of the gas-exchange valves, a qualitative and quantitative change in oil viscosity can be determined. With corresponding calibration, an absolute determination of the oil viscosity is also possible here.

In one preferred construction, a control signal determined from a lambda controller from a measured oxygen concentration in the exhaust gas is used as the parameter for characterizing the exhaust gas composition. In this way, an already present, suitable operating parameter can be accessed directly. Additional sensors are likewise not required.

Preferably, a correction of the oxygen concentration performed by the lambda controller is used as the suitable parameter. In this concept, not the absolute value of the oxygen concentration is evaluated, but instead the control response of an existing lambda controller. This touches on the idea that, for example, due to aging phenomena, the viscosity of the motor oil increases and that in comparison to the previous state - by use of the lambda controller it results in a defective setting and the oxygen content measured in the exhaust gas deviates from the expected oxygen content—for unchanged oil properties. This error is corrected by the lambda controller. This correction that is eventually a correction of the oxygen concentration in the exhaust gas, is used for determining the viscosity parameter. Determining a viscosity parameter from the parameters of a lambda controller can be drawn, in particular, from a German Patent Application with the title “Method and also control device for determining a viscosity parameter of a motor oil” filed at the same time as the priority application by the same applicant.

The correction value or the oxygen concentration is preferably correlated, in turn, with respect to its possible parameter values with oil viscosities or with viscosity grades separated into a low-temperature range and into a high- temperature range. In a high-temperature range, for example, the lowest available correction value is correlated with a motor oil viscosity that is too low for the engine operation and the highest available correction value is correlated with a viscous high-temperature oil, for example, the SAE class W50 or W60. In a low-temperature range, the highest available correction value is then correlated accordingly with the most viscous possible low-temperature oil, which is designated, for example, by SAE 20W.

According to the already mentioned parameters for specifying an engine friction or for specifying the setting time of the desired oil pressure during a startup phase of the internal combustion engine, a parameter for characterizing the setting speed of a camshaft adjustment could also be used for characterizing the oil viscosity. A quicker setting speed here gives evidence of a low viscosity and a rather slow setting speed gives evidence of a rather high viscosity of the motor oil. Accordingly, in turn, the correlation of the lowest available parameter value with an oil viscosity that is too low for the operation of the internal combustion engine and the highest available parameter range (separated into a low-temperature range and into a high-temperature range) can be correlated with a viscous motor oil corresponding to summer or winter classifications.

In addition, for characterizing the oil viscosity, a model already used in the engine control can be referenced that describes the change in viscosity of the motor oil being used due to aging. Such a model is based on the assumption of the time expiration of the polymers added to modern multi-grade oils.

In addition to the actual operating parameters named above, for the specified method a parameter for indicating an oil change could be used. Such a parameter is to be taken directly from today's modern engine controls. By the use of these parameters, the system can directly determine a state of a new motor oil and thus relate future changes to this state.

In another preferred construction, the viscosity parameter is determined while adding a priority sequence or weighting to the parameters used for the individual predictions. In the case of the already mentioned, especially preferred parameters, weighting in the specified sequence is preferred. Thus, reference is made to the significance of each parameter with respect to oil viscosity.

The mentioned objective is further met according to the invention by a control device for the electronic engine control of an internal combustion engine that is constructed to detect and/or to determine a plurality of operating parameters characterizing an operating state of the internal combustion engine, to evaluate several parameters permitting at least a rough conclusion on the viscosity of the motor oil for each individual prediction on the viscosity of the motor oil at different times from these operating parameters, to detect changes in the individual predictions at comparable operating points of the internal combustion engine relative to a state of new motor oil, and to determine a viscosity parameter of a motor oil from the changes in the multiple individual predictions.

The control device can be used for obtaining a conclusion on the oil viscosity in the sensors already present in a modern engine control. The corresponding evaluations and calculations can be realized by software.

The control device is constructed, in particular, for performing the method described above. The advantages mentioned here can be transferred analogously to the control device.

### BRIEF DESCRIPTION OF THE DRAWINGS

Embodiments of the invention will be explained in detail with reference to the drawings. Shown are:

FIG. 1 schematically for an internal combustion engine with hydraulic actuation of the gas-exchange valves, a control device obtaining a viscosity parameter from several individual predictions,

FIG. 2 schematically for an internal combustion engine with camshaft adjustment, a control device for obtaining a viscosity parameter from several individual predictions,

FIG. 3 schematically, the profile of the excitation current for a hydraulically actuated solenoid valve, and

FIG. 4 schematically, the movement sequence of a hydraulically actuated gas-exchange valve.

### DETAILED DESCRIPTION OF THE PREFERRED EMBODIMENTS

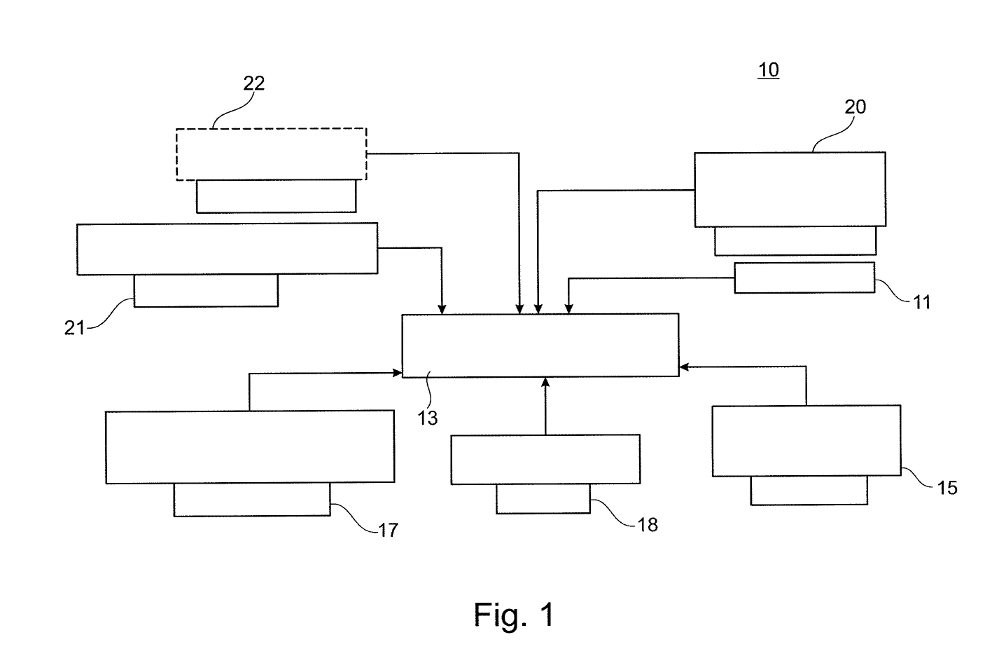

In FIG. 1, a control device 10 for the electronic engine control of an internal combustion engine with a hydraulic actuation of the gas-exchange valves is shown schematically. In this case, the engine provides both camshaft adjustment and also a direct hydraulic actuation of the gas-exchange valves.

The control device 10 comprises a master computer 11 that is the core of the electronic engine control. A central analysis unit 13 that determines a conclusion on the current status of the oil viscosity by a plurality of selected operating parameters made available to the engine control is implemented as software or as additional hardware.

To this end, the central analysis unit 13 presently includes the parameters from the solenoid valve control for the hydraulic actuation of the gas-exchange valves. For this purpose, a corresponding solenoid valve analyzer 15 is formed by software that determines switching periods from the excitation currents of the solenoid valves and here outputs prediction values for a current oil viscosity. The central analysis unit 13 further includes operating parameters from an existing lambda controller 17. In particular, access is made here to the correction value of the lambda controller that indicates a changed oxygen content in the exhaust gas relative to a new motor oil or relative to the originally set state.

In addition, the output of a forecast unit 18 is used by the central analysis unit as a parameter for the evaluation for an individual prediction. The forecast unit 18 is here part of the engine control 10 and includes an aging model for forecasting the oil viscosity with increasing operating period.

In addition, from the existing oil-pressure sensor of the engine control, an operating parameter is polled or determined that specifies the setting time, during a startup phase, until reaching the desired oil pressure. To this end, a corresponding oil-pressure analyzer 20 is constructed by software.

Furthermore, for determining individual predictions with respect to oil viscosity, a friction value of the engine is used as a suitable parameter. This friction value can be taken from the engine control that determines this value, for example, while idling, from the difference between the desired and actual rotational speeds. For determining the individual prediction for the oil viscosity, a friction analyzer 22 is implemented or realized by software.

Furthermore, the setting speed of the camshaft adjuster is used as a suitable operating parameter. The corresponding response times can be taken from existing sensors or can be derived from the corresponding, existing parameters. For determining a conclusion on the oil viscosity, a phase analyzer 21 is realized.

The central analysis unit 13 monitors time changes in the determined individual predictions with respect to each other, wherein individual predictions are compared with each other at comparable operating points of the internal combustion engine. From the corresponding changes, the central analysis unit 13 derives a viscosity parameter that describes qualitatively and optionally also quantitatively the current viscosity state of the motor oil. The viscosity parameter is, in particular, a viscosity grade, in particular, the SAE specification, and also indicates, in this respect, the current temperature response of the viscosity of the motor oil.

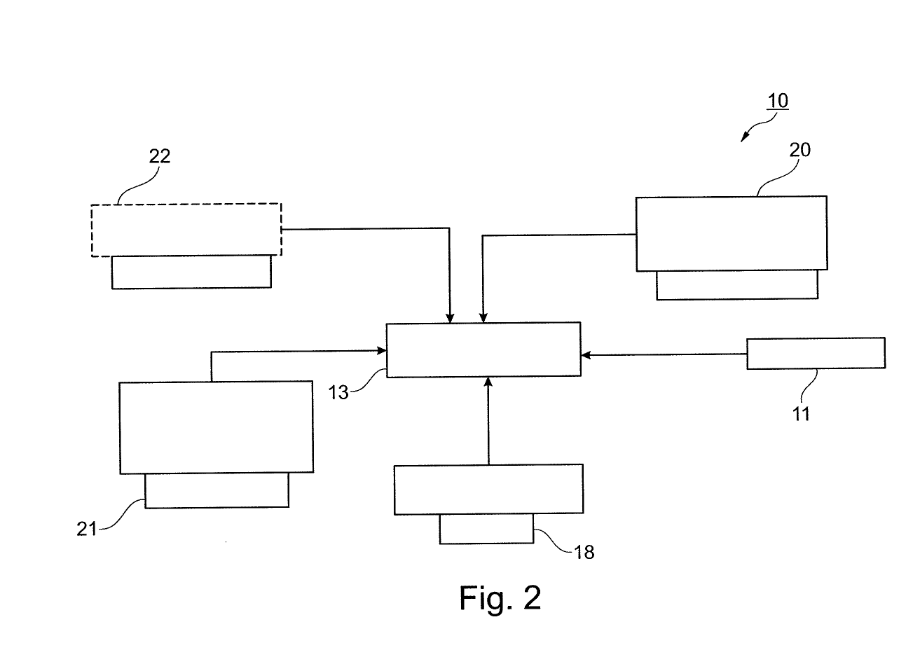

In FIG. 2, a corresponding control device 10 for an internal combustion engine is provided with camshaft adjustment without direct hydraulic actuation of the gas-exchange valves. Consequently, the lambda controller 17 is eliminated for determining the viscosity parameter, as well as the solenoid valve analyzer 15 that analyzes the switching period of a solenoid valve in the hydraulic linkage between the cam and the corresponding gas-exchange valve. The other components are provided accordingly and designated in the same manner.

In both constructions, the control device 10 also detects, by use of the master computer 11, a parameter that indicates that an oil change has been performed. With the parameter value indicating an oil change, the central analysis unit is reset to a certain extent. The subsequent individual predictions are allocated to a state that corresponds to a new motor oil. Subsequent individual predictions are calibrated or correlated in this way.

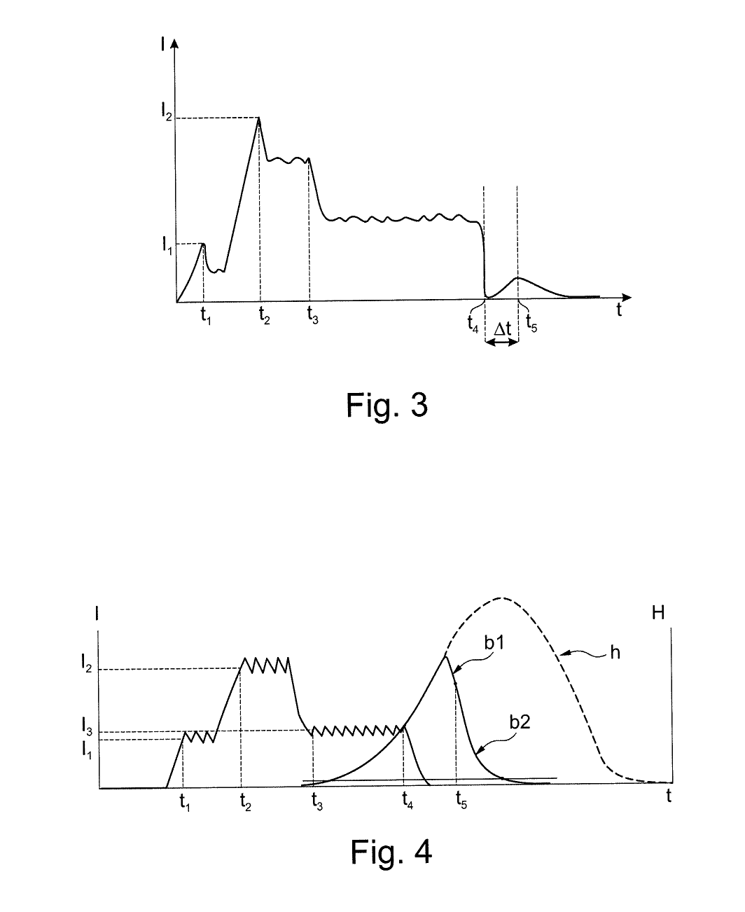

In FIG. 3, a typical profile of the excitation current 1 is shown, how it is arranged between a cam and the allocated gas-exchange valve for controlling a solenoid valve in the hydraulic linkage. Typically, the coil is first loaded with an activation current I₁ at a time t₁. This activation current I₁ merely leads to a magnetic bias, but not to a movement of the closing element. For activation, that is, closing of the valve that allows an oil flow into a compensation chamber, this is charged with a closing current I₂ at time t₂. At this time, the closing element moves into its closed position. Due to an inductive response, the closing current decreases somewhat. After closing, the current is typically reduced to a holding current 13 at a time t₃.

For opening the valve, at a time t₄ the current feed is deactivated. Based on a restoring spring, the closing element moves in the direction of the open position. Here, an inductive response is generated, in turn, that expresses itself in a current pulse following time t₄. The profile of this current pulse correlates with the movement of the closing element of the controlled solenoid valve. A defined position of the closing element, especially its open position, can be derived unambiguously from the profile of the current pulse. This is achieved in the embodiment at time t₅.

The times t₄ and t₅ therefore correspond to a first and a second position of the controlled solenoid valve. The time period At between t₄ and t₅ represents the deactivation time for the switching process and thus the adjustment process of the solenoid valve. The time period At is linked directly with the viscosity of the motor oil being used. Studies have shown that there is a linear relationship between the time period At and the kinematic viscosity.

In FIG. 4, initially a typical excitation current I is shown like that used for activation of a solenoid valve for controlling the gas-exchange valves. This excitation current I corresponds in its profile essentially to that already shown in FIG. 3. At a time t₃, the current is typically reduced to a holding current I₃ that is greater than the activation current I₁. The time t₄ is specified by the corresponding engine control as a function of the current requirements.

In addition, in FIG. 4, the allocated profile of the stroke H of the gas-exchange valve controlled accordingly is plotted in a time profile. The dashed line reproduces an envelope curve h that reproduces the lifting movement of the gas-exchange valve for permanently closed solenoid valve. The envelope curve h therefore corresponds to the movement of the gas-exchange valve when this necessarily and directly follows the movement of the cam.

Through the deactivation of the excitation current I at time t₄, the stroke movement of the gas-exchange valve deviates from the envelope curve h. The gas-exchange valve closes at an earlier time. The actual profile of the lifting movement of the gas-exchange valve for the illustrated profile of the excitation current I is shown by the continuous line. As is to be seen, after an initial phase that is identical with the envelope curve h, the profile of the lifting movement deviates from the envelope curve h. The falling movement, that is, the closing of the gas-exchange valve, is presently designated as the ballistic phase, because in this state the gas-exchange valve is retracted into the closed position based on just the spring force. The spring force here works against the system-dependent friction forces. These are caused decisively by the viscosity of the motor oil being used. The ballistic phase can here be divided into two sub-regions bl and b2. The first sub-phase b1 is caused by a closing movement of the solenoid valve for which the same considerations apply as for the gas-exchange valve. Also here the adjustment of the valve is performed, actuated by spring force, against the friction force caused decisively by the viscosity. The second ballistic sub-phase b2 is then caused just by the gas-exchange valve. The solenoid valve is located in its closed position at time t₅.

The gas-exchange valve considered here is an intake valve. The surface area under the curve for the lifting movement of the gas-exchange valve thus correlates with the quantity of air drawn in for a combustion cycle and thus defines the mixture ratio between fuel and air—at a defined injection quantity of the injected fuel. Thus, the oxygen content in the exhaust gas is also simultaneously influenced. This operating parameter or an operating parameter derived from this can be drawn from a lambda controller and allows conclusions to be made on the oil viscosity.

At a higher viscosity of the motor oil, for example, the ballistic phase b1, b2 shifts to the right, i.e., the gas-exchange valve closes more slowly. The basis for this is to be seen in the higher friction force caused by the higher viscosity. Accordingly, the oxygen concentration in the exhaust gas increases. The lambda controller must output a higher correction value for setting the same desired operating state.

The boxes of FIGS. 1 and 2 include the following text:

11 Master computer

13 Central analysis unit

15 Solenoid valve analyzer: Detection of the oil state based on activation time and deactivation time

17 Lambda controller: Function for detecting a typical lambda controller deviation as a consequence of the oil viscosity

18 Forecast unit: Oil-degradation model

20 Oil-pressure analyzer: Analysis of the oil-pressure signal

21 Phase analyzer: Function for analysis of the camshaft-adjustment (response) time

22 Friction analyzer: Estimation of the friction value of the engine

List of reference numbers

10 Control device

11 Master computer

13 Central analysis unit

15 Solenoid valve analyzer

17 Lambda controller

18 Prediction unit

20 Oil-pressure analyzer

21 Phase analyzer

22 Friction analyzer

1. A method for determining a viscosity parameter of a motor oil in an internal combustion engine, comprising at least one of detecting or determining a plurality of operating parameters characterizing an operating state of the internal combustion engine for an electronic engine control, evaluating several of the parameters to provide at least a rough conclusion on a viscosity of the motor oil from the operating parameters at different times for an individual prediction on the viscosity of the motor oil, detecting changes in the individual predictions at comparable working points of the internal combustion engine relative to a state of new motor oil, and determining the viscosity parameter from the changes in the several individual predictions.

2. The method according to claim 1, wherein a temperature of the motor oil is detected and wherein an available parameter range is calibrated, for temperatures above a specified limiting value, to a first range of prediction values for classifying the oil and is calibrated, for temperatures below the limiting value, to a second range of prediction values for classifying the oil.

3. The method according to claim 1, wherein an oil grade changed in comparison with the new motor oil is determined from the changes in the individual predictions.

4. The method according to claim 1, wherein upon determining a viscosity that is too low or too high for the internal combustion engine from the changes in the individual predictions, the method further comprising at least one of issuing an advance warning or blocking continued operation or a startup of the internal combustion engine.

5. The method according to claim 1, further comprising determining the fact that an oil change has been performed from the changes in the individual predictions.

6. The method according to claim 1, wherein after an oil change, the changes in the individual predictions are detected with respect to an output state given by the oil change.

7. The method according to claim 1, wherein the parameters used for the evaluation for an individual prediction are selected from a group consisting of:
parameters for characterizing an adjustment speed of a hydraulic component, an electrically controllable switching valve, parameters for characterizing an exhaust-gas composition, an oxygen concentration, parameters for characterizing an oil change based on a model by at least one of aging or wear, parameters for characterizing the oil pressure, parameters for characterizing the setting speed of a camshaft adjustment, ands parameters for characterizing a friction value of the internal combustion engine.

8. The method according to claim 7, wherein additional parameters are used for indicating an oil change.

9. The method according to claim 1, wherein the internal combustion engine is operated with a hydraulic adjustment of the gas-exchange valves.

10. The method according to claim 1, wherein the internal combustion engine is operated with a camshaft adjustment.

11. The method according to claim 1, wherein the viscosity parameter is determined while adding a priority sequence or weighting of the parameters used for the individual predictions.

12. The method according to claim 1, wherein the viscosity parameter is used as an input parameter for the electronic engine control.

13. The method according to claim 7, wherein at least one of an activation period or deactivation period of a solenoid valve in a hydraulic linkage for activation of the gas-exchange valves is used as a parameter for characterizing an adjustment speed of a hydraulic component.

14. The method according to claim 13, wherein at least one of the activation period or the deactivation period is determined from an inductive response of an excitation current.

15. The method according to claim 7, wherein a control signal determined by a lambda controller from a measured oxygen concentration in the exhaust gas is used as a parameter for characterizing the exhaust-gas composition.

16. The method according to claim 15, wherein a correction performed by the lambda controller of the oxygen concentration is used as a parameter.

17. A control device for the electronic engine control of an internal combustion engine comprising a computer that is constructed to at least one of detect or to determine a plurality of operating parameters characterizing an operating state of the internal combustion engine, to evaluate several parameters permitting at least a rough conclusion on a viscosity of a motor oil at different times for an individual prediction, and for each individual prediction on the viscosity of the motor oil from the operating parameters at different times, to detect changes in the individual predictions at comparable operating points of the internal combustion engine relative to a state of a new motor oil, and to determine a viscosity parameter of the motor oil from the changes in the several individual predictions.
